(19) United States
(12) Patent Application Publication
(10) Pub. No.: US 2025/0271263 A1
(43) Pub. Date: Aug. 28, 2025

(54) Laser Projection Tool with Curved Window

(71) Applicant: Milwaukee Electric Tool Corporation, Brookfield, WI (US)

(72) Inventors: Luke I. Bradley, Oconomowoc, WI (US); David W. Draeger, Sussex, WI (US); Benjamin D. Gabbard, Milwaukee, WI (US); Jacob D. Hadfield, Mukwonago, WI (US); Max D. Mutza, Pewaukee, WI (US); Matthew H. Ogden, Milwaukee, WI (US)

(21) Appl. No.: 19/016,759

(22) Filed: Jan. 10, 2025

Related U.S. Application Data
(60) Provisional application No. 63/556,687, filed on Feb. 22, 2024.

(51) Int. Cl. G01C 15/00; G03B 21/14

(52) U.S. Cl. CPC G01C 15/004; G03B 21/145

(57) ABSTRACT

Various embodiments of a laser projection tool are provided. The laser projection tool includes a housing that defines an opening and a window coupled to the housing that covers the opening. A laser device is located within the housing and is configured to emit a laser through the window. In a certain embodiment, the window includes a first curved section curved about a first axis and a second curved section curved about a second axis. The first curved section extends between a frost side of the housing and a top side of the housing. The second curved section extends between the front side of the housing and a left side of the housing.

### CROSS-REFERENCE TO RELATED PATENT APPLICATION

The present application claims the benefit of and priority to U.S. Application No. 63/556,687 filed on Feb. 22, 2024, which is incorporated herein by reference in its entirety.

### BACKGROUND OF THE INVENTION

The present invention relates generally to the field of tools. The present invention relates specifically to a laser projection tool, such as a point laser tool, a line laser tool, a plane laser tool, etc., that projects a laser onto a workpiece.

### SUMMARY OF THE INVENTION

One embodiment of the invention relates to a laser projection assembly including a housing, a window, and a laser device. The housing includes a front side, a top side, a left side, and a right side. An opening is defined by the housing, and the opening extends along at least a first portion of the front side, a second portion of the top side, and a third portion of the left side. The window is coupled to the housing and covers the opening. The window includes a first flat surface section, a first curved section, and a second curved section. The first flat surface section extends along the front side. The first curved section is curved about a first axis, and the first curved section extends between the front side and the top side. The second curved section is curved about a second axis, and the second curved section extends between the front side and the left side. The second axis is perpendicular to the first axis. The laser device is coupled to the housing and is configured to emit a laser through the window.

Another embodiment of the invention relates to a tool for projecting a laser onto a workpiece. The tool includes a housing, a window, and a laser device. The housing includes a first side, a second side, and a third side. The second side is coupled to a first edge of the first side, and the first side is oriented at a non-zero angle with respect to the first side. The third side is coupled to a second edge of the first side, and the third side is oriented at a non-zero angle with respect to the first side. The window extends along at least a first portion of the first side, a second portion of the second side, and a third portion of the third side. The window includes a first curved section and a second curved section. The first curved section is curved about a first axis, and the first curved section extends between the first side and the second side. The second curved section is curved about a second axis, and the second curved section extends between the first side and the third side. The window is formed from a single, continuous, contiguous piece of material. The laser device is coupled to the housing and is configured to emit a laser through the window.

Another embodiment of the invention relates to a laser projection tool including a housing defining an opening, a window coupled to the housing, and a line laser device. The window covers the opening and includes a first curved section, a second curved section, and a flat surface. The first curved section is curved about a first axis, and the first curved section extends between a first side of the housing and a second side of the housing. The second curved section is curved about a second axis, and the second curved section extends between the first side of the housing and a third side of the housing. The flat surface section extends between the first curved section and the second curved section. The window is formed from a single, continuous, contiguous piece of material. The line laser device is coupled to the housing and is configured to emit a first laser through the window. The first laser is projected as a planar fan beam through the window. The planar fan beam has a fan angle of 90 degrees to 270 degrees.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a laser projection tool, according to an exemplary embodiment;

FIG. 2 is a detailed view of the laser projection tool of FIG. 1, according to an exemplary embodiment;

FIG. 3 is a perspective view from below of the laser projection tool of FIG. 1, according to an exemplary embodiment;

FIG. 4 is a perspective view of the laser projection tool of FIG. 1 in an activated state, according to an exemplary embodiment;

FIG. 5 is a perspective view of a laser projection tool, according to an exemplary embodiment; and

FIG. 6 is a perspective view of a laser projection tool, according to an exemplary embodiment.

### DETAILED DESCRIPTION

Referring generally to the figures, various embodiments of a laser projection tool, such as a laser level with a curved window, are shown. In general, the laser projection tool discussed herein includes a housing having an opening that extends along multiple sides of the housing and a window covering the opening, which allow a laser device to project a laser beam in multiple directions and through wide fan angles. In specific embodiments discussed herein, the housing includes a single, continuous window over the opening having curved corners to accommodate the geometry of the housing as the opening extends from one side of the housing to another. The window of the laser projection tool is configured to extend to multiple sides of the housing in perpendicular directions (e.g., from a front side to a top side and from a front side to a left and/or right side).

In contrast to the laser projection tool discussed herein, conventional laser projection tools typically include windows that are either flat (i.e., extending along a single plane), include only either flat or curved sections, or that include only a single curved section. These configurations typically require multiple windows to accommodate projection of lasers in multiple directions, with large projection angles, and/or out of multiple sides of a laser housing. The curved window of the laser projection tool discussed herein provides a design that addresses these issues while also providing a more durable window and allowing for wider laser fan angles than traditional flat windows.

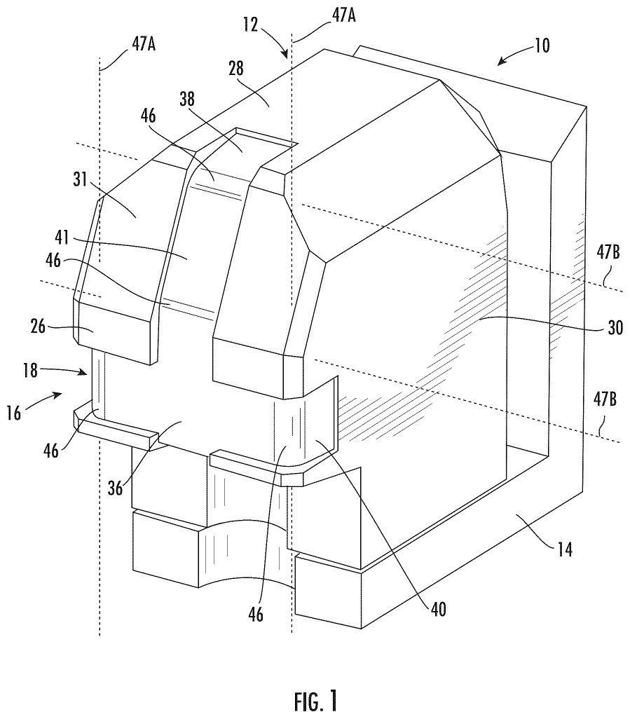

Referring to FIG. 1, a laser projection assembly or laser projection device 10 is shown according to an exemplary embodiment. Laser projection device 10 includes a laser device housing 12 and a frame 14. Laser device housing 12 is mounted on frame 14. Frame 14 is configured to allow for adjustment of laser projection device 10 with respect to a workpiece and/or to allow for mounting laser projection device 10 to accessories or work surfaces. Laser device housing 12 includes various electronic components, laser light sources and optics associated with a laser projection tool, and includes one or more laser projection openings, shown as laser opening 16 defined by housing 12, through which the internal laser light sources project laser lines, points, etc. onto a workpiece or work surface. Laser device housing 12 includes a window 18 that covers laser opening 16. Window 18 is coupled to housing 12 and positioned within housing 12. Window 18 is formed from a single, continuous, contiguous, piece of material. Window 18 is formed from a transparent material, such as a glass material or a plastic material (e.g., polycarbonate, polymethyl methacrylate, acrylic), to allow the laser light to transmit out of laser device housing 12 through window 18.

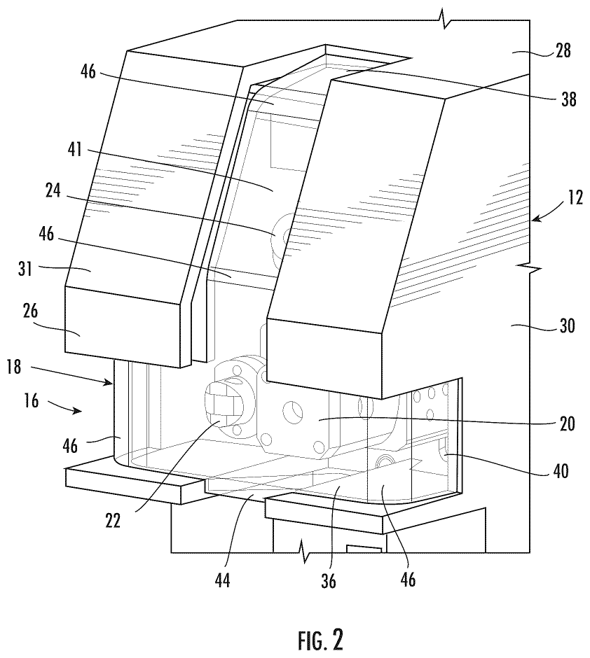

Referring to FIG. 2, laser device housing 12 may house any of a variety of laser devices configured to emit a laser (e.g., a line laser, a point laser, a plane laser, etc.). In various embodiments, at least one laser device is coupled to housing 12 and positioned within housing 12 such that the laser device is surrounded by housing 12. In specific embodiments, laser device housing 12 supports a point laser device 20 that projects one or more dots of laser light onto a work surface or workpiece. Point laser device 20 emits a laser as a linear beam through window 18 and the linear beam shows as a dot on a work surface or workpiece. In a specific embodiment, point laser device 20 may be a 5-dot laser system which projects three dots in a horizontal plane, each dot 90° from the adjacent dot in the horizontal plane, as well as a dot straight above and straight below the device. In other embodiments, the point laser device may project fewer points in any combination of the 5-dot laser system.

In some embodiments, laser device housing 12 supports a first line laser device 22 that projects a horizontal line on a work surface. Line laser device 22 is configured to emit a laser as a planar beam and the planar beam shows as a line on a workpiece or work surface. Specifically, first line laser device 22 projects a horizontal line. Laser device housing 12 supports a second line laser device 24 that projects a vertical line on a work surface. Line laser device 24 is configured to emit a laser as a planar beam and the planar beam shows as a line on a workpiece or work surface. Specifically, second line laser device 24 projects a vertical line that intersects with the horizontal line projected by first line laser device 22. In specific embodiments, the laser device supported within laser device housing 12 includes a self-leveling mechanism that levels the laser output even if the housing of the laser system is not level.

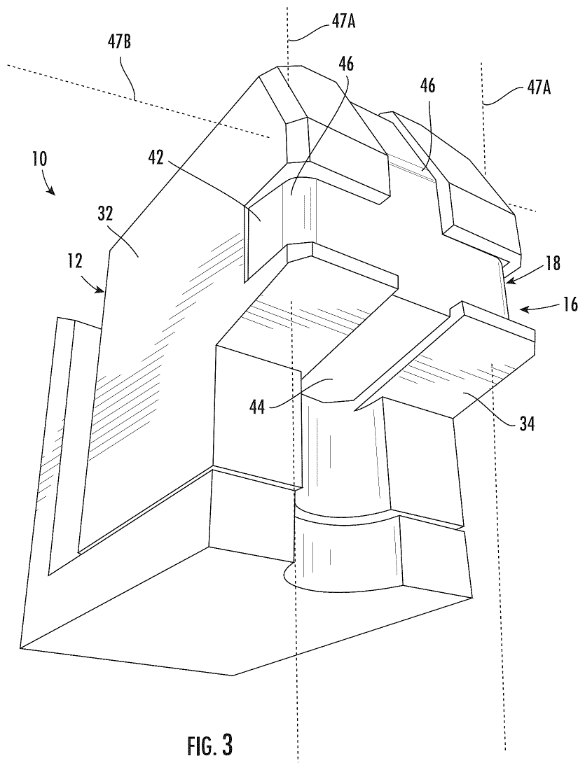

As shown in FIG. 1, laser device housing 12 includes a first or front side 26, a second or top side 28, and a third or left side 30. In some embodiments, laser device housing 12 includes a fifth or angled front side 31 between front side 26 and top side 28. Referring to FIG. 3, laser device housing also includes a fourth or right side 32 opposite left side 30 and a sixth or downward facing side 34 facing away from top side 28. Top side 28, left side 30, right side 32, angled front side 31, and downward facing side 34 are each oriented at non-zero angles with respect to front side 26.

Laser opening 16 extends along housing 12. As shown, laser opening 16 extends horizontally across front side 26 of laser device housing 12. Laser opening 16 further extends to and along a portion of left side 30, as shown in FIGS. 1 and 2, and a portion of right side 32, as shown in FIG. 3. Laser opening 16 also extends vertically across the front side 26 of laser device housing 12. Laser opening 16 further extends to and across angled front side 31 and extends to and along a portion of top side 28, as shown in FIGS. 1 and 2. In some embodiments, laser opening 16 also extends to and along a portion of downward facing side 34, as shown in FIGS. 2 and 3. In other embodiments, laser device housing 12 includes a separate laser opening in downward facing side 34 that is discontinuous with respect to laser opening 16 for point laser device 20 to project a laser downward.

In a specific embodiment, window 18 includes a plurality of flat surface sections and a plurality of curved sections. Window 18 includes a first or front flat surface section 36, a second or top flat surface section 38, a third or left flat surface section 40, a fifth or angled front flat surface section 41, a fourth or right flat surface section 42, and a sixth or downward facing flat surface section 44. Front flat surface section 36 extends across laser opening 16 between portions of front side 26.

As shown, flat surface sections 36, 38, 40, 41, 42, and 44 each extend along a single plane such that flat surface sections do not include any bends or curves. In some embodiments, front flat surface section 36 is substantially parallel to front side 26. Top flat surface section 38 extends across laser opening 16 between portions of top side 28. Left flat surface section 40 extends across laser opening 16 between portions of left side 30. Angled front flat surface section 41 extends across laser opening 16 between portions of angled front side 31. In some embodiments, angled front flat surface section 41 is substantially parallel to angled front side 31. Right flat surface section 42 extends across laser opening 16 between portions of right side 32. Downward facing flat surface section 44 extends across laser opening 16 between portions of downward facing side 34.

Window 18 includes one of the plurality of curved sections 46 between each adjacent flat surface section, the curved sections 46 having arcuate shapes. As shown, a first curved section 46 extends between front side 26 and angled top side 31, a second curved section 46 extends between angled top side 31 and top side 28, a third curved section 46 extends between front side 26 and left side 30 and a fourth curved section 46 extends between front side 26 and right side 32. As shown, front flat section 36 extends between third curved section and fourth curved section 46. Front flat section 36 also extends between downward flat section 44 and first curved section 46. Angled front flat section 41 extends between first curved section 46 and second curved section 46.

Curved sections 46 each are curved about an axis 47. The curved sections 46 between front flat surface section 36 and left flat surface section 40 and between front flat surface section 36 and right flat surface section 42 each curve about vertical axes 47A (i.e., axes that extend through and/or substantially perpendicular to top side 28 and downward facing side 34). Vertical axes 47A are substantially parallel to each other. The curved sections 46 between front flat surface section 36 and angled front flat surface section 41 and between angled front flat surface section 41 and top flat surface section 38 each curve about horizontal axes 47B (i.e., axes that extend through and/or substantially perpendicular to left side 30 and right side 32). Horizontal axes 47B are substantially parallel to each other. In a specific embodiment, vertical axes 47A and horizontal axes 47B are perpendicular to each other. In some embodiments, window 18 includes a sharp angle between front flat surface section 36 and downward facing flat surface section 44. Curved sections 46 each have an external surface area that is less than the external surface area of the adjacent flat surface sections of window 18. The curved geometry of window 18 provides a structure that is believed to be more durable than traditional laser projection tools including a single flat window and/or separate abutting windows.

Window 18 is configured to extend across laser opening 16 such that window 18 and laser device housing 12 cooperate to enclose the laser projection devices within laser device housing 12. In a specific embodiment, window 18 is formed as a single, continuous, contiguous, integral component including both the curved and flat surface sections disclosed herein. By enclosing the laser projection devices with a single window that extends along multiple sides of laser device housing 12, the embodiment discussed herein is believed to reduce or prevent the ingress of dirt or debris more effectively than conventional laser projection devices that include multiple abutting flat windows. Further, by molding window 18 as a single component, the embodiment discussed herein is believed to reduce manufacturing and assembly costs relative to some conventional laser projection devices that require molding and assembly of multiple windows.

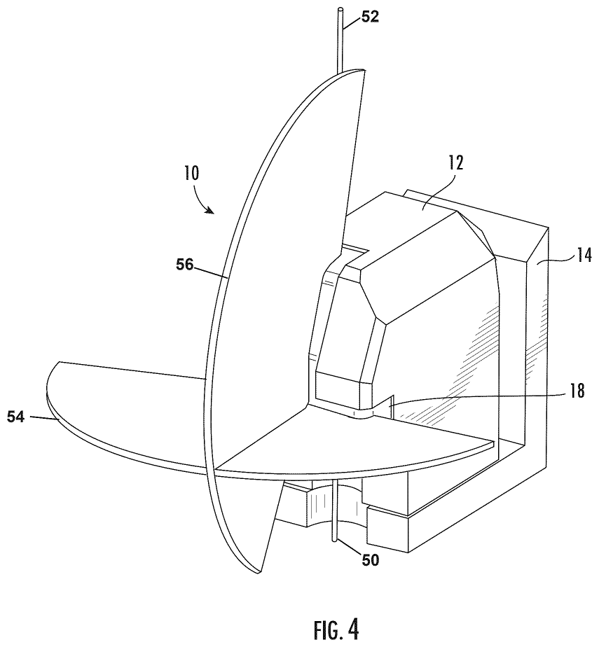

Referring to FIG. 4, laser projection device 10 is shown in an activated state. Point laser device 20 emits a down dot laser 50 through downward facing flat surface section 44 and an upwards dot laser 52 through top flat surface section 38. Lasers 50 and 52 are linear beams are projected as dots (or points) on a work surface or workpiece. A point laser device 20 emits lasers 50 and 52 through window 18 in a vertical direction.

First line laser device 22 projects a laser 54 as a fan or partial plane beam. In particular, laser 54 is a horizontal line laser which is emitted through window 18 as a planar fan beam and projected as a line on a work surface or workpiece. Second line laser device 24 projects a laser 56 as a fan or partial plane beam. In particular, laser 56 is a vertical line laser which is emitted through window 18 as a planar fan beam and projected as a line on a work surface or workpiece. Laser 54 and laser 56 intersect with each other. In a specific embodiment, laser 54 and laser 56 are perpendicular to each other.

The curved geometry of window 18 allows laser projection device 10 to emit a vertical point laser, horizontal line laser, and vertical line laser through window 18 without requiring multiple windows separate windows or multiple separate laser openings. Further, by extending to and along multiple sides of laser device housing 12, window 18 allows laser projection device 10 to enclose the laser projection devices and project the horizontal line laser and vertical line laser through greater fan angles than a similarly sized laser projection device having a flat window that only extends along one side of the housing. In some embodiments, the horizontal line laser and/or the vertical line laser (such as lasers 54 and 56) are emitted as planar fan beams having fan angles of 90 degrees to 270 degrees. In a specific embodiment, lasers are projected through window 18 at fan angles between 90 and 270 degrees, and more specifically between 130 and 220 degrees. In a specific embodiment, the fan angle is about 150 degrees.

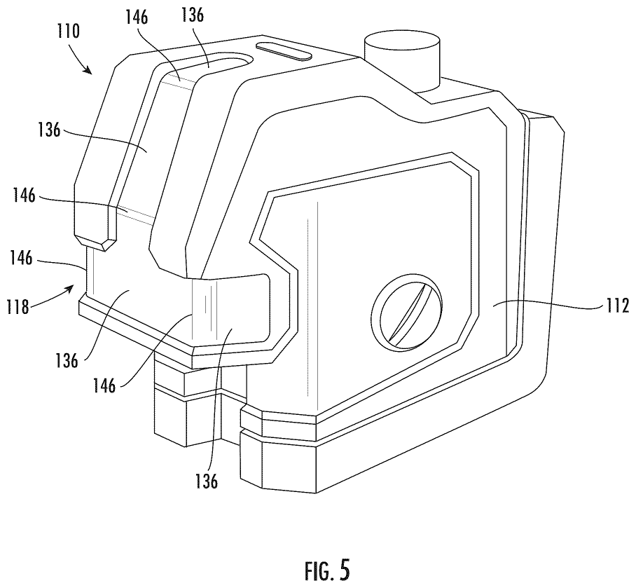

Referring to FIG. 5, a laser projection device 110 is shown, according to an exemplary embodiment. Laser projection device 110 is substantially the same as laser projection device 10 except for the differences discussed herein. Laser projection device 110 includes a laser device housing 112 and window 118. Window 118 includes a plurality of flat surface sections 136 that extend between portions of sides of laser device housing 112. Window 118 includes corners 146 between flat surface sections 136. In some embodiments, corners 146 are angles formed at the area of contact between adjacent abutting flat surface sections 136 such that the direction in which window 118 extends abruptly changes at corners 146.

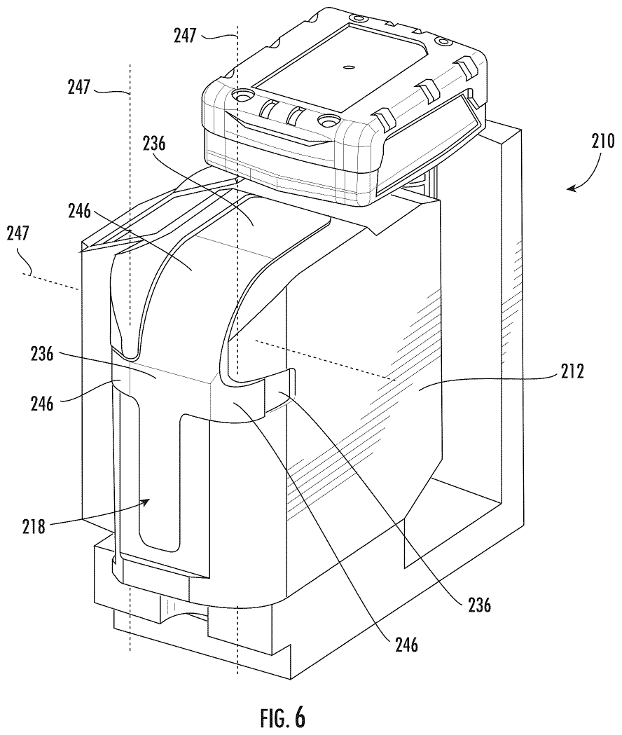

Referring to FIG. 6, a laser projection device 210 is shown, according to an exemplary embodiment. Laser projection device 210 is substantially the same as laser projection devices 10 and 110, except for the differences discussed herein. Laser projection device 210 includes a laser device housing 212 and window 218. In a specific embodiment, window 218 includes a plurality of flat surface sections 236 that extend between portions of sides of laser device housing 212. Window 218 includes curved sections 246 between adjacent flat surface sections 236. Curved sections 246 are curved about axes 247. Each curved section 246 has an external surface area that is greater than the external surface area of at least one of the adjacent flat surface sections 236. Window 218 extends along a front side of laser device housing 212 substantially below a horizontal section of window 218 that extends along portions of and between a left side, front side, and right side of laser device housing 212. In other embodiments, window 218 of laser projection device 210 does not include any flat surface sections such that the entire external surface of window 218 is curved.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A laser projection assembly, comprising:
a housing comprising:
a front side;
a top side;
a left side;
a right side opposite the left side; and
an opening defined by the housing, the opening extending along at least a first portion of the front side, a second portion of the top side, and a third portion of the left side;
a window coupled to the housing and covering the opening, the window comprising:
a first flat surface section extending along the front side;
a first curved section curved about a first axis, the first curved section extending between the front side and the top side; and
a second curved section curved about a second axis, the second curved section extending between the front side and the left side, wherein the second axis is perpendicular to the first axis; and
a laser device coupled to the housing and configured to emit a laser through the window.

2. The laser projection assembly of claim 1, wherein the window is formed from a single, continuous, contiguous piece of material.

3. The laser projection assembly of claim 1, wherein the opening extends along a fourth portion of the right side, and wherein the window further comprises a third curved section curved about a third axis, the third curved section extending between the front side and the right side.

4. The laser projection assembly of claim 3, wherein the third axis is parallel to the second axis.

5. The laser projection assembly of claim 1, wherein the window further comprises a second flat surface section, wherein the second flat surface section extends along the top side of the housing.

6. The laser projection assembly of claim 1, further comprising a frame, wherein the housing is mounted on the frame.

7. The laser projection assembly of claim 1, wherein the laser device is configured to emit the laser as a linear beam through the window.

8. The laser projection assembly of claim 1, wherein the laser device is configured to emit the laser as a planar fan beam having a fan angle of 90 degrees to 270 degrees.

9. A tool for projecting a laser onto a workpiece, the tool comprising:
a housing comprising:
a first side;
a second side coupled to a first edge of the first side, wherein the second side is oriented at a non-zero angle with respect to the first side;
a third side coupled to a second edge of the first side, wherein the third side is oriented at a non-zero angle with respect to the first side;
a window extending along at least a first portion of the first side, a second portion of the second side, and a third portion of the third side, the window comprising:
a first curved section curved about a first axis, the first curved section extending between the first side and the second side; and
a second curved section curved about a second axis, the second curved section extending between the first side and the third side;
wherein the window is formed from a single, continuous, contiguous piece of material; and
a laser device coupled to the housing and configured to emit a laser through the window.

10. The tool of claim 9, wherein the second axis is perpendicular to the first axis.

11. The tool of claim 9, wherein the second axis is parallel to the first axis.

12. The tool of claim 9, wherein the window further comprises a flat surface section extending along the first side between first curved section and second curved section.

13. The tool of claim 9, wherein the window made of a glass material.

14. The tool of claim 9, wherein the window made of a plastic material.

15. A laser projection tool, comprising:
a housing defining an opening;
a window coupled to the housing and covering the opening, the window comprising:
a first curved section curved about a first axis, the first curved section extending between a first side of the housing and a second side of the housing; and
a second curved section curved about a second axis, the second curved section extending between the first side of the housing and a third side of the housing;
a flat surface section extending between the first curved section and the second curved section;
wherein the window is formed from a single, continuous, contiguous piece of material; and
a line laser device coupled to the housing and configured to emit a first laser through the window, wherein the first laser projected as a planar fan beam through window, wherein the planar fan beam has a fan angle of 90 degrees to 270 degrees.

16. The laser projection tool of claim 15, wherein the fan angle is between 130 degrees and 220 degrees.

17. The laser projection tool of claim 15, wherein the first axis is perpendicular to the second axis.

18. The laser projection tool of claim 15, further comprising a second laser device configured to emit a second laser through the window.

19. The laser projection tool of claim 18, wherein the second laser device configured to emit the second laser as a linear beam through the window.

20. The laser projection tool of claim 18, wherein the second laser device is configured to emit the second laser as a planar fan beam through the window, and wherein the first laser and the second laser are oriented perpendicular to each other.
